(19) United States
(12) Patent Application Publication
(10) Pub. No.: US 2010/0310348 A1
(43) Pub. Date: Dec. 9, 2010

(54) APPARATUS FOR TRANSFERRING PRODUCTS

(75) Inventors: Andrea Zecchini, Bologna (IT); Daniele Davi, Ferrara (IT)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: CT PACK S.r.l., Crespellano (Bologna) (IT)

(21) Appl. No.: 12/791,931

(22) Filed: Jun. 2, 2010

(30) Foreign Application Priority Data
Jun. 4, 2009 (IT) BO2009A000361

(51) Int. Cl. B65G 43/00; B65G 1/133

(52) U.S. Cl. 414/751.1; 198/444

(57) ABSTRACT

An apparatus for transferring products for ice-cream parlors comprises a pick-up device (2) provided with a grippers (3) for gripping an orderly row of products (100), the pick-up device (2) being movable between a position for loading and unloading the products (100), a sensor element (4) for generating a signal (PS) indicating the presence or absence of products in the row of products (100), a plurality of housing elements (5), each for receiving a product (100), a positioning device (6) acting on the housing elements (5) for positioning them in the unloading position so that they receive the products (100) released by the grippers (3), a retaining device (7) acting on the housing elements (5) and associated with a sensor element (4) and with the positioning device (6) for transferring a housing element (5) to the positioning device (6) depending on the signal (PS) generated by the sensor element (4).

### CROSS-REFERENCE TO RELATED APPLICATIONS

This application claims priority to Italian Patent Application No. BO2009A000361 filed Jun. 4, 2009, which application is incorporated by reference herein.

### BACKGROUND OF THE INVENTION

The present invention relates to an apparatus for transferring products.

In particular the present invention relates to an apparatus for transferring products between two operating stations in a production plant.

The present invention is applicable in particular to plants for the production and boxing of confectionery products, in particular for ice cream parlors, such as ice cream cones, cone-like articles containing a frozen liquid, and the like.

In these plants the products are prepared in one or more preparation stations and then conveyed to a boxing or packaging station where the individual finished products are arranged inside a packaging for transportation or storage.

In the preparation stations, semi-finished products (such as ice cream cone wafers or cone-like containers for ice lollies) are completed and individually wrapped so as to form the finished product.

During these operations, both the semi-finished products and the finished products are transported into the various stations in an orderly manner, namely arranged in lines and rows inside special housing or support elements.

It may happen that a particular housing or support element does not contain the respective finished product, for example because the latter is defective (and has therefore been eliminated) or because filling of the housing element has been missed out.

Obviously, at the outlet of the boxing station it is necessary to ensure that each package contains a predetermined and always identical number of finished products.

For this reason, the boxing station may not simply be connected in series to the preparation stations, but a suitable product transfer apparatus, which allows an orderly and continuous series of finished products to be transferred to the boxing station, must be placed between the stations.

In the prior art, product transfer apparatus, essentially forming a buffer zone for accumulating finished products, and a device for gradually releasing finished products which have accumulated inside the buffer zone are placed between the preparation stations and the boxing station.

In particular, the product transfer apparatus according to the prior art comprise a conveyor belt or the like on which the finished products leaving the preparation stations are placed.

Transfer of the finished products onto the conveyor belt is performed by an operator or, more frequently, by automatic unloading and loading devices (so as to speed up the operations for transfer onto the conveyor belt).

The conveyor belt conveys the finished products in a more or less orderly manner towards an accumulation zone (for example consisting of a mechanical barrier) where the products accumulate, therefore eliminating any empty spaces created by failure to pick up a finished product from the preparation stations.

The conveyor belt and the accumulation zone define the buffer zone.

In the product transfer apparatus according to the prior art, a further conveyor is provided downstream of the accumulation zone for receiving in an orderly manner one or more orderly rows of finished products.

In particular, finished products removed from the accumulation zone are released onto this further conveyor at regular intervals so that finished products arranged in orderly rows and without empty positions reach the boxing station.

The product transfer apparatus according to the prior art briefly described above have a number of drawbacks.

In particular, when the finished products are situated inside the buffer zone, control over the products is completely lost.

In fact, the products are transported without actual control over their real position and spatial orientation since they simply rest on, and are therefore transported by, the conveyor belt.

It may therefore happen that one or more products are transported in inappropriate positions or that these products may change their spatial orientation during transportation.

Since the information relating to the position and spatial orientation of each product must be known for correct boxing, the information which is lost when passing through the buffer zone must be recovered.

Recovery of this information is not always easy and it in any case requires devices especially provided for this purpose.

Moreover, the loss of control over the products during their transfer into the buffer zone may be unacceptable especially when the finished products are particularly delicate since it is not possible to know beforehand what will actually happen to each individual product inside the buffer zone.

Furthermore, the buffer zone, in particular in plants which have a high production output, may be large in size, therefore requiring a suitable amount of space inside the factory.

### SUMMARY OF THE INVENTION

In this connection, the technical task forming the basis of the present invention is to provide a product transfer apparatus which overcomes the above-mentioned drawbacks of the prior art.

In particular, an object of the present invention is to provide a product transfer apparatus able to keep control over each product.

A further object of the present invention is to provide an apparatus for transferring small-size products.

The technical task mentioned and the objects specified are substantially achieved by a product transfer apparatus having the technical features described in one or more of the accompanying claims.

### BRIEF DESCRIPTION OF THE DRAWINGS

Further features and advantages of the present invention will emerge more clearly from the description, provided by way of a non-limiting example, of a preferred, but not exclusive embodiment of a product transfer apparatus, as shown in the accompanying drawings in which:

FIG. 1 is the schematic top plan view of a product transfer apparatus according to the present invention;

FIG. 2 is a side view of a detail of the apparatus of FIG. 1 in a first operating condition;

FIG. 3 is a side view of the detail of FIG. 2 in a second operating condition;

FIG. 4 is a side view of the detail of FIG. 2 in a third operating condition;

FIG. 5 is a front view of a further detail of the apparatus of FIG. 1 in a first operating condition;

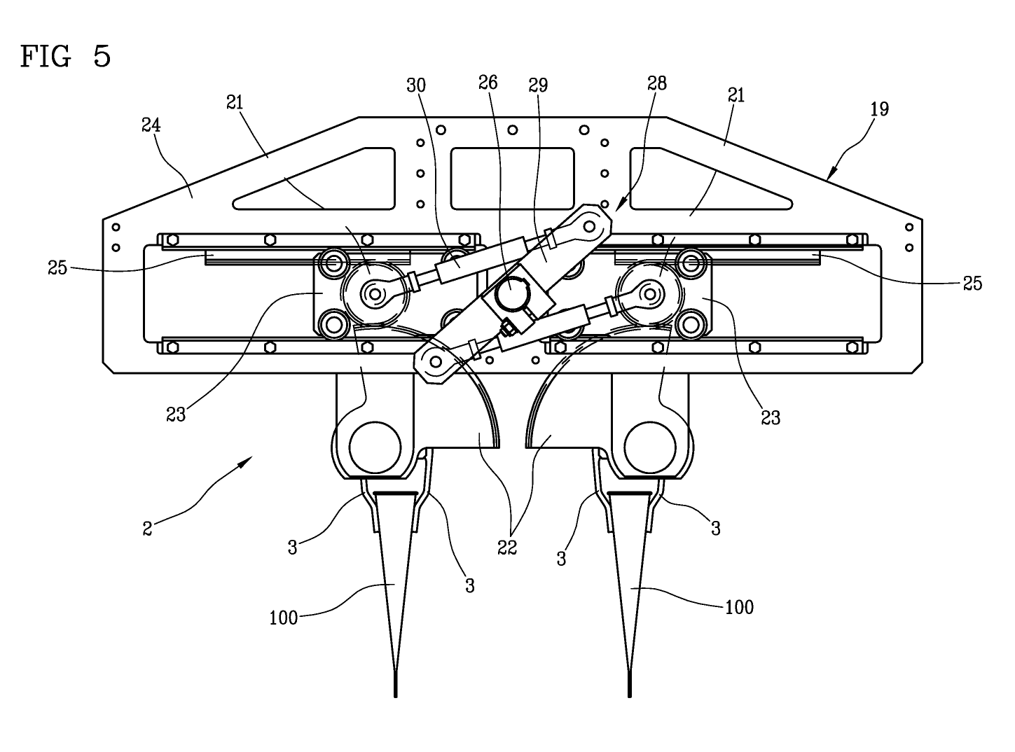

FIG. 6 is a front view of the detail of FIG. 5 in a second operating condition;

FIG. 7 is a side view of the detail of FIG. 5; and

FIG. 8 shows block diagram representing parts of the apparatus of FIG. 1.

### DESCRIPTION OF THE PREFERRED EMBODIMENTS

An apparatus for transferring products according to the present invention is denoted overall in the accompanying drawings by the numeral 1.

The apparatus 1 forms part of a plant for the production of products for ice cream parlors, downstream of one or more stations for preparing and finishing a product 100 and upstream of a boxing station.

Obviously the apparatus 1 may be located between any two other stations of a production plant.

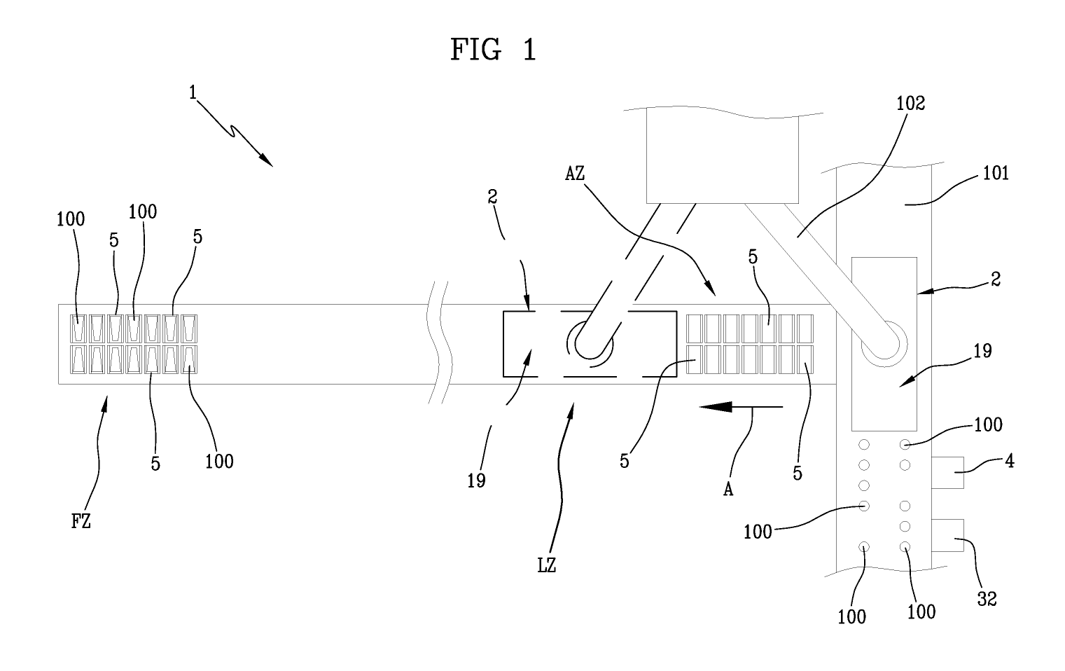

Preferably, the plant 1 is located downstream of a freezing tunnel which transports a plurality of orderly rows of products 100 on a conveyor belt 101 (shown schematically in FIG. 1).

An “orderly row of products” is understood as meaning in the context of the present invention a sequence of products arranged in line next to each other or behind each other.

The products in a row are not necessarily spaced at regular intervals; in particular between one product and the following or preceding product there may be a gap, i.e. a position in which a product should be present, but in reality is not present.

The description which follows will be provided with specific reference to finished ice-cream parlor products in the form of cones or cone-like articles.

However, the apparatus 1 is able to operate with finished or semi-finished ice-cream parlor products having forms also different from that of a cone.

The apparatus 1 comprises a pick-up and release device 2 for an orderly row of products 100, comprising a plurality of grippers 3, each of which is designed to grip a product 100.

The pick-up and release device 2 is movable between a loading position in which the grippers 3 grip the orderly row of products 100 (position shown in continuous lines in FIG. 1) and an unloading position in which the grippers 3 release the products 100 (position shown in broken lines in FIG. 1).

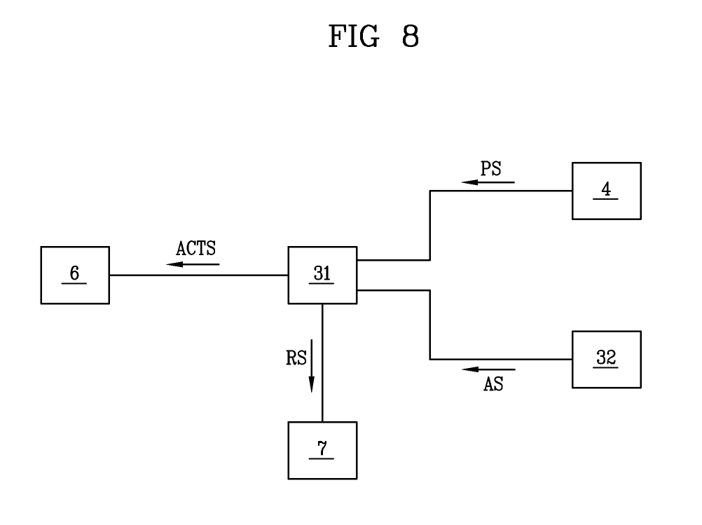

The apparatus also comprises a sensor element 4 (schematically shown in FIGS. 1 and 8) for generating a presence signal PS indicating the presence or absence of products 100 in each orderly row of products.

The apparatus 1 also comprises a plurality of housing elements 5, each of which is designed to house a product 100, a positioning device 6 acting on the housing elements 5 so as to feed them forward in succession and position them in the unloading position of the pick-up device 2 so that the housing elements 5 receive the products released by the grippers 3.

The apparatus 1 comprises a retaining device 7 acting on the housing elements 5 and operatively associated with the sensor element 4 and with the positioning device 6 for transferring a housing element to the positioning device 6 depending on the presence signal PS generated by the sensor element 4.

In this way it is possible to maintain complete control over each product during transfer between one station and the next.

In fact, the products 100 are picked up by the pick-up device 2 and then the latter keeps control over the picked-up products, namely the law of motion of each product is known in advance, since obviously the law of motion of the pick-up device 2 is known. Once the products are positioned inside the housing elements 5, it is also known that a product will be present in each housing element 5 and therefore, in this case also, control over the individual products 100 is not lost.

Maintaining control over the individual products also involves re-ordering the products so as to form consecutive series of products, namely series of products where there are no gaps between one product and the following or preceding product.

In fact, the retaining device 7 causes the release of housing elements 5 to the positioning device 6 depending on the presence or absence of products 100 within the line which is transferred by the pick-up device 2.

The positioning device 6 therefore positions in the unloading zone a number of housing elements 5 corresponding to the products 100 which are to be unloaded, eliminating any empty positions originally present in the row of products 100.

In the preferred embodiment of the invention, the positioning device 6 comprises a closed-loop conveyor 8 provided with a plurality of retaining members 9.

The conveyor 8 is a timing chain wound around pulleys 10, one of which, 11, is motor-driven.

In particular, the conveyor 8 is operated by a stepper motor 11, namely a motor of the type able to feed the timing chain forward in a discontinuous manner.

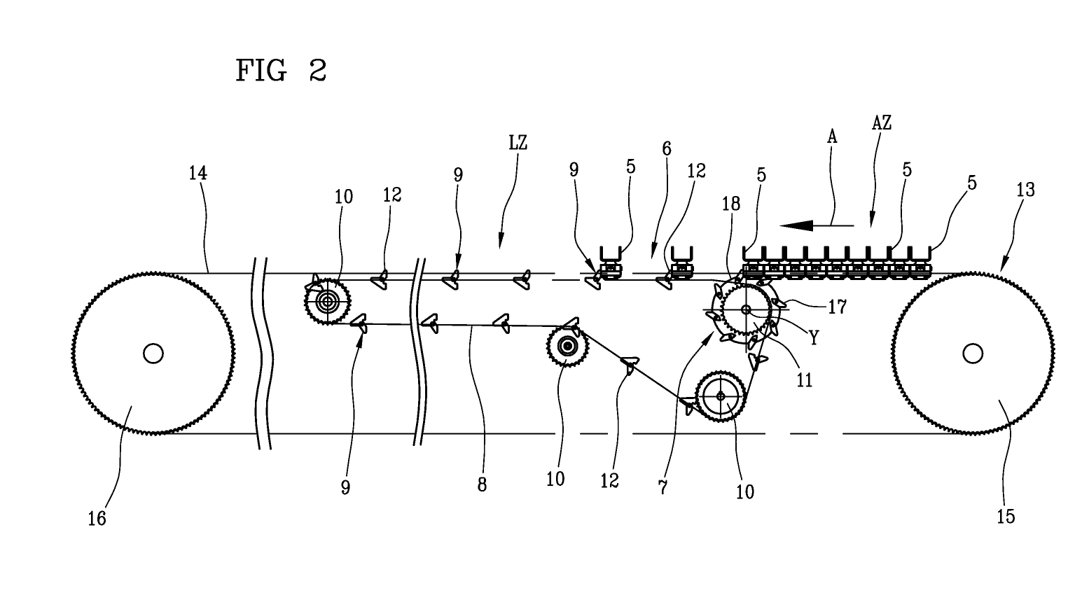

As shown in FIGS. 2 to 4, the retaining members 9 consist of locating sliders 12 which are constrained in a compliant manner to the timing chain 8 and which make contact frontally with the housing elements 5, preventing them from moving forward freely along the timing chain 8.

In other words, the housing elements 5 advance in the feeding direction A only when the locating sliders 12 advance in the feeding direction A.

It should be noted, in fact, that the housing elements 5 are constrained to a conveying device 13 which moves the elements between a zone AZ (see FIG. 1) for accumulating empty housing elements 5, located upstream of the retaining device 7, a zone LZ for loading the housing elements (coinciding with the unloading position of the pick-up device 2) and a zone FZ for accumulating full housing elements 5 (i.e. containing respective products 100), located downstream of the positioning device 7.

The conveying device 13 comprises a closed-loop conveyor 14 on which the housing elements 5 are constrained in floating fashion so as to be held on the conveyor 14 by friction.

In particular, the conveyor 14 passes through an opening present in each of the housing elements 5 in such a way that the latter rest on the conveyor 14.

The feeding movement of the conveyor therefore causes the feeding movement of the housing elements 5 in the feeding direction A.

When a housing element 5 encounters an obstacle, for example one of the retaining members 9, in its feeding direction, the constraining action between conveyor 14 and housing element 5 ceases, namely the conveyor no longer moves the housing element 5 along with it, but merely supports the latter.

In this latter condition the conveyor 14 passes freely inside the opening of the housing element 5.

It should be noted that the portion of the housing element 5 interacting with the retaining members 9 is different, namely does not coincide, even partly, with the portion of the housing element 5 which has the opening, namely with the portion interacting with the conveyor 14.

Each housing element 5 has a bottom portion with the opening and a top portion which is preferably U-shaped for housing and containing a product 100.

The conveyor 14 forms a closed loop around two pulleys 15 and is operated by a motor 16 for moving the conveyor 14 with continuous motion.

It should be noted that the paths followed by the timing chain 8 and the conveyor 14 are partly parallel and spaced from each other (see FIGS. 2 to 4) so that the retaining members 9 act on the housing elements 5 transported by the conveyor 14.

As mentioned above, the retaining device 7 is associated with the positioning device 6.

The retaining device comprises at least one stop member 17 which can be switched between a stop position and a release position for a housing element 5 so as to release in a controlled manner housing elements 5 to the timing chain 8.

In particular, the stop members 17 are formed by a sprocket wheel 18 rotatable about an axis Y perpendicular to the feeding direction A of the housing elements 5.

As shown in FIGS. 2 to 4, the sprocket wheel 18 is located at the inlet of the positioning device 6.

In particular, the axis of rotation Y of the sprocket wheel 18 coincides with the axis of rotation of the first pulley 10 around which the conveyor 8 is wound.

The teeth of the sprocket wheel 18 intercept the housing elements 5 which are moved by the conveying device 13, stopping them.

In this way, the housing elements 5 accumulate one after another upstream of the sprocket wheel 18, defining the accumulation zone AZ for the empty housing elements 5.

It should be noted that the stop members 17 act on the housing elements 5 along portions which are different both from the portions acted on by the retaining members 9 and from the opening through which the conveyor 14 of the conveying device 13 passes.

When the stop members 17 release a housing element 5, the latter is moved by the conveying device 13 until it reaches a retaining member 9 of the positioning device 6.

In particular, the housing elements 5 are released by the stop members 17 by means of rotation of the sprocket wheel 18 which, rotating, moves away and positions, outside the volume of the housing element 5, the tooth 18 which retained the housing element 5.

Release of the housing element 5, i.e. rotation of the sprocket wheel 18, is dependent on the presence signal PS generated by the sensor element 4, in the manner which will be clarified below.

The pick-up device 2 has, as mentioned above, the function of transferring the products 100 to the housing elements 5 prepared by the positioning device 6 to receive the products 100.

In the preferred embodiment, the pick-up device 2 comprises a gripping head 19 connected to a robot arm 102.

The robot arm 102 has the function of moving the gripping head 19 within space and providing the head with a power source for moving the components which form the gripping head 19.

The gripping head 19 comprises the above-mentioned grippers 3.

In the preferred embodiment, the grippers 3 are operated pneumatically between the open or release position and the closed or pick-up position.

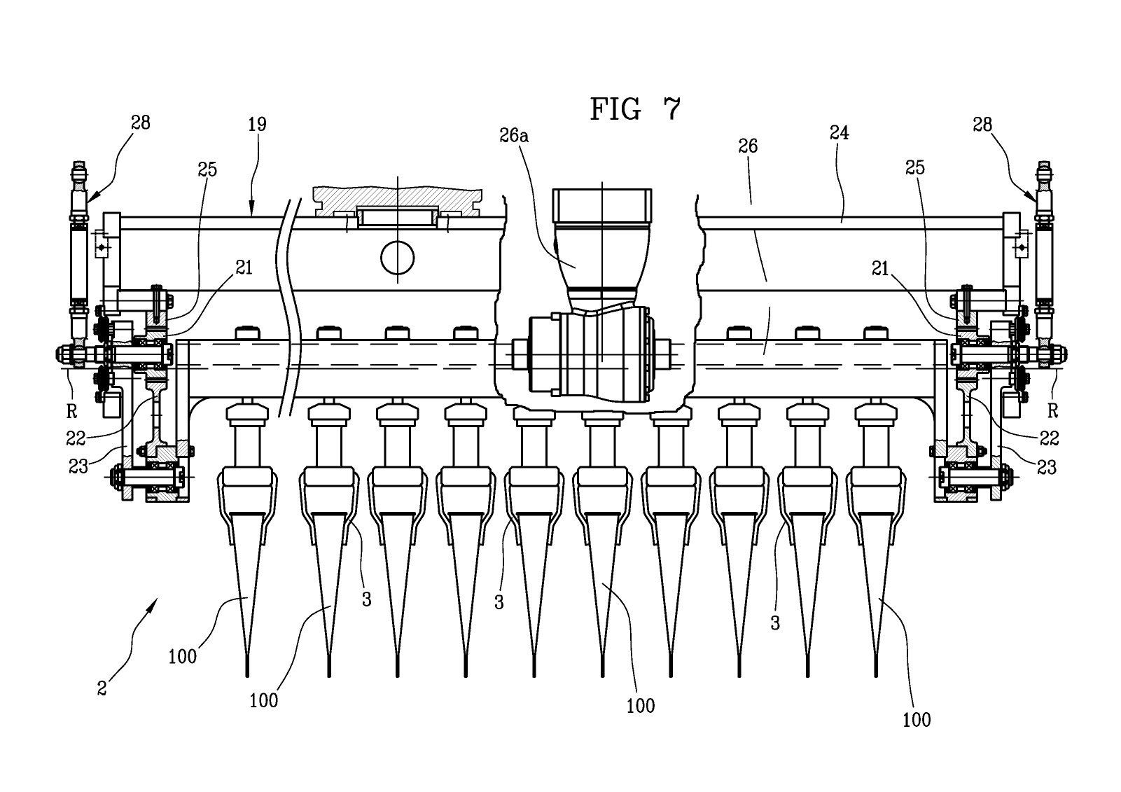

In particular, the grippers 3 are arranged along at least one row and are spaced from each other in a manner substantially corresponding to the distance present between the seats which house the products 100 to be picked up (FIG. 7).

In the preferred embodiment of the invention, the rows of grippers consist of two rows parallel to each other so as to be able to pick up two rows of products during each working cycle of the pick-up device 2.

The grippers 3 are moved by actuator members 20 so that the two rows of grippers 3 are moved away from each other and simultaneously rotated during the working stroke of the pick-up device 2 between the loading position and the unloading position.

In particular, the two rows of grippers 3 are rotated about two axes R of rotation which are parallel to each other and coincide with the axes along which the grippers 3 are aligned.

Rotation is performed between two positions substantially perpendicular to each other, preferably between a vertical starting position and a horizontal end position.

The starting position coincides with the position for picking up the products 100 and the end position coincides with the position for releasing the products 100.

In the preferred embodiment the (cone-shaped) products 100 are presented to the pick-up device 2 in a vertical position, namely with the larger section positioned above the tapered end section, and are released to the housing elements 5 in a horizontal position, namely lying on one of their generatrices.

It should be noted that the grippers 3 are moved away so as to allow rotation thereof.

In fact, in the preferred embodiment of the invention, rotation of the grippers is performed so that the products 100 retained by the grippers 3 (which engage with the larger section of the cone-like article) face each other (namely with their end sections facing).

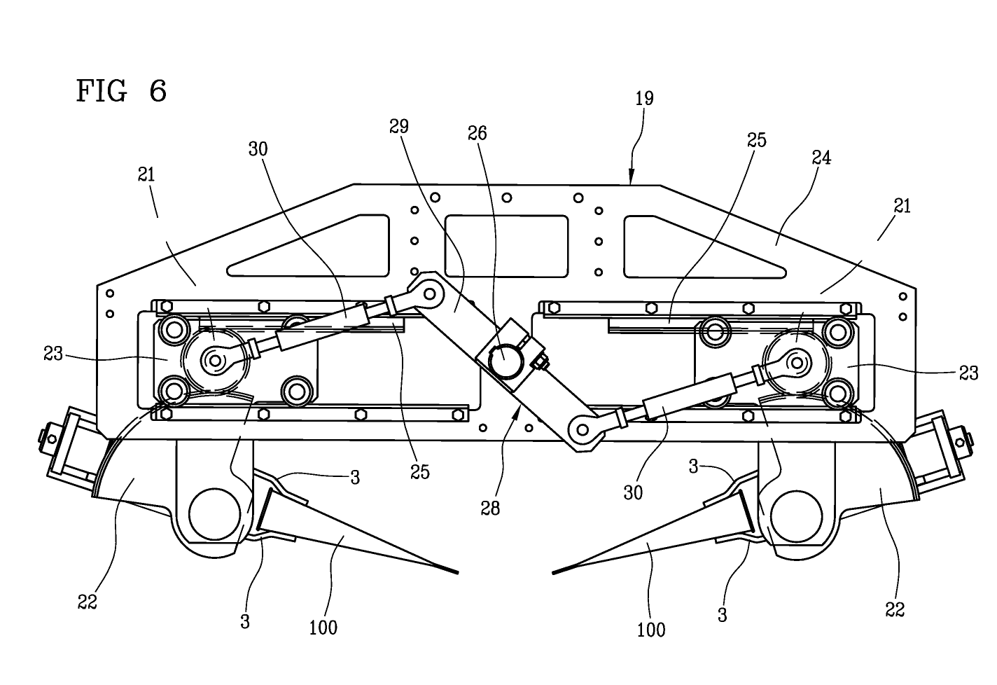

Preferably, the actuator members 20 comprise two gear wheels 21 able to travel in a direction substantially perpendicular to the axes of rotation R of the grippers 3 and in opposite directions (FIG. 6).

A toothed circular sector 22 engaged by a respective gear wheel 21 is integral with each row of grippers 3.

Each toothed circular sector 22 is rotatable about an axis parallel to the axis of rotation R of the row of grippers 3 to which it is constrained.

Displacement of a gear wheel 21, and therefore its rolling movement, causes rotation of the toothed circular sector 22 and therefore rotation of a row of grippers 3.

In order to ensure correct travel of the gear wheels 21, each gear wheel 21 is rotatably constrained to a slide 23 which is able to slide in the same direction of travel as the gear wheel 21 (FIG. 6).

This slides 23 are guided along special straight guides (not shown in detail) formed in the frame 24 of the gripping head 19.

During its travel movement, each gear wheel 21 engages with a straight rack 25 and is therefore made to rotate.

Each toothed circular sector 22 is constrained to a respective slide 23 so that displacement of the slide 23 causes displacement of the toothed circular sector 22 and therefore displacement of the row of grippers 3.

In accordance with the above description, the row of grippers 3 perform a roto-translational movement during operation of the actuator members 19.

The actuator members 19 moreover cause displacement of the slides 23 in opposite directions.

In particular, the actuator members 19 comprise a motor-driven shaft 26 (shown in broken lines in FIG. 7) rotatable about an axis parallel to the axes of rotation R of the rows of grippers 3.

This motor-driven shaft 26 is preferably located between the shafts 27 on which the rows of grippers 3 are mounted.

The motor-driven shaft 26 comprises a power take-off 26a for drawing mechanical power necessary for its operation by the robot arm 102.

Respective mechanisms 28 for converting the rotary movement of the shaft 26 into an alternating movement of the slides 23 are positioned at the ends of the driven shaft 26.

In the preferred embodiment, these mechanisms 28 consist of a connecting rod 29 and a crank 30 (see FIG. 6).

During use, the pick-up device 2 is lowered onto the belt 101 conveying the products 100 to be transferred and picks up the products via the grippers 3 (continuous lines in FIG. 1).

The pick-up device 2 then moves into the unloading position where the products 100 are transferred to the housing elements 5 (broken lines in FIG. 1).

In order to allow correct positioning of the housing elements 5 underneath the pick-up device 2 (in the unloading position), the apparatus 1 comprises a command and control device 31 (schematically indicated in FIG. 8 together with the associated signals received and sent).

The command and control device is operatively associated with the sensor element 4 and with a further sensor element 32 (also schematically shown in FIGS. 1 and 8).

The further sensor element 32 generates and sends to the command and control device 31 an approach signal AS indicating that the pick-up and release device 2 has actually reached or almost reached the unloading position.

In the preferred embodiment, the further sensor element 32 generates an approach signal AS indicating that the pick-up device 2 has almost reached the unloading position, in particular generates an approach signal SA indicating that the products 100 are in a position ready for being picked up by the pick-up device 2.

By combining this signal AS with the known law of motion of the pick-up device 2 it is possible to determine the exact moment in which the pick-up device 2 is situated in the position for unloading the products 100.

This combination and comparison operation is performed by the command and control device 31.

Preferably, the further sensor element 32 is an encoder acting on the roller of the conveyor belt 101 for the products 100 to be picked up. The arrangement, on the conveyor belt 101, of the products 100 to be picked up is known and therefore the signal AS generated by the encoder is sufficient for the above-mentioned purpose.

The command and control device 31 receives the approach signal AS and generates and sends an activation signal ACTS to the positioning device 6 in order to feed forward in succession the housing elements 5 and position them underneath the pick-up device 2.

In particular, the positioning device 6 positions its retaining members 9 opposite the grippers 3 and in so doing positions the housing elements 5 so that they engage with the retaining members 9 underneath the pick-up device 2.

As mentioned, it may be the case that not all the grippers 3 are conveying a product 100.

In this case, in order to recreate a continuous sequence of housing elements 5 containing a respective product 100, the command and control device 31 receives the presence signal PS sent by the sensor element 4 and generates (and sends) a retaining signal RS to the retaining device 7 in order to allow or prevent transfer of a housing element 5 to the positioning device 6.

The sensor element 4 which generates the presence signal PS may be a contact sensor, an image processor which acquires the image of the products to be conveyed and determines the presence or absence thereof, or any other instrument suitable for the purpose.

The retaining device 7, upon receiving the retaining signal RS, releases or retains a housing element 5 depending on the presence or absence of a product 100 in the position assumed by the housing element on the positioning device 6.

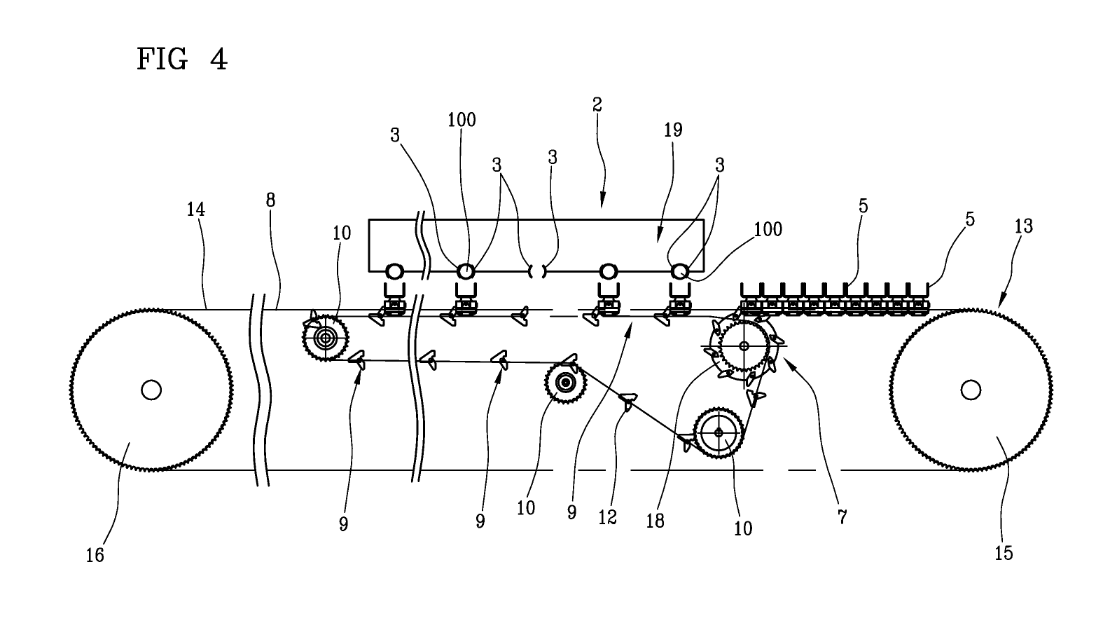

By way of example, with reference to FIGS. 2 to 4, let us assume that a gripper 3 of the pick-up device 2 (the third gripper from the right when viewing FIG. 4) is not conveying any product 100 (FIG. 4 shows the grippers only in schematic form).

In this case, the retaining device 7 receives a retaining signal RS indicating that the third gripper 3 is not conveying any product 100, or alternatively (or in combination), a plurality of retaining signals RS indicating the fact that the grippers 3 other than the third gripper are conveying products 100.

When this signal is received, the stop member 17 releases two housing elements 5.

In particular, a first housing element 5 which is picked up by the positioning device 6 and fed forward one step along the timing chain 8 is released, followed by release of a second housing element 5 which is also fed forward one step (it should be noted that in the meantime the first housing element released has moved forward two steps), as shown in FIG. 2.

As mentioned above, the positioning device 6 is activated only upon receiving the activation signal ACTS.

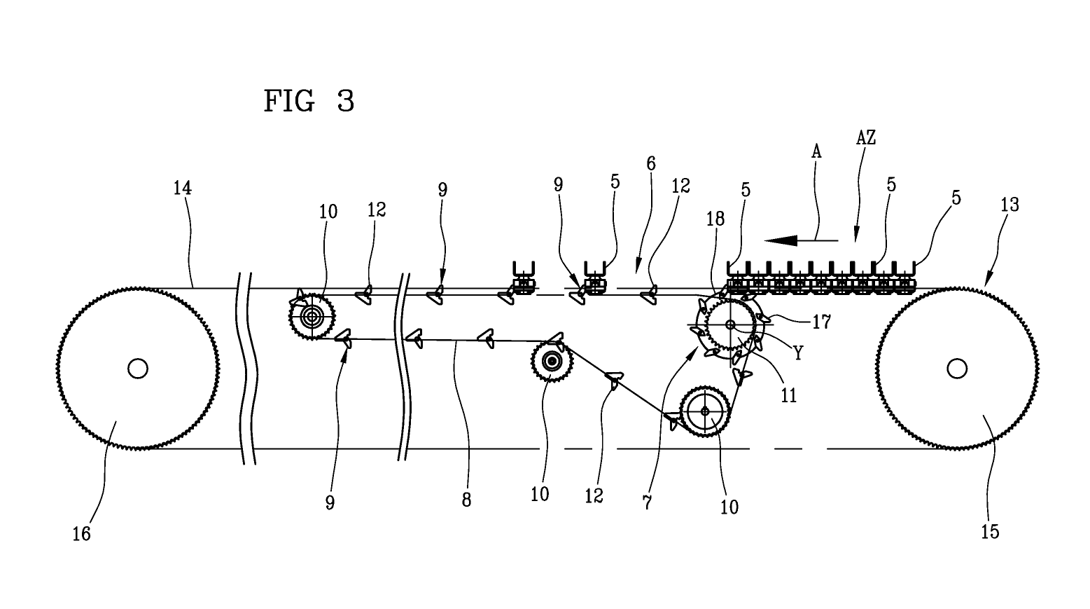

The stop member 17 retains the third housing element 5, while the positioning device 6 moves the first and second housing elements 5 forward a further step (FIG. 3).

At this point, the stop member 17 releases all the further housing elements 5 in a manner similar to that already performed for the first and second housing elements 5, until all the housing elements 5 have been positioned in the unloading zone of the pick-up device 2 (FIG. 4).

It should be noted that the final configuration envisages that, for each product conveyed by the pick-up device 2, there is only one housing element 5 ready to receive the corresponding product 100.

When the products 100 are released into the housing elements 5, the latter are moved away from the loading zone LZ and sent to the zone FZ for accumulating full housing elements, where the housing elements are accumulated one against another so as to create an orderly sequence of products 100.

The invention therefore achieves the predefined objects.

The apparatus for transferring products is able to maintain control over each product.

In fact, the products 100 are picked up by the pick-up device 2 and then the latter keeps control over the picked-up products, namely the law of motion of each product is known in advance, since obviously the law of motion of the pick-up device 2 is known. Once the products are positioned inside the housing elements 5, it is also known that a product will be present in each housing element 5 and therefore, in this case also, control over the individual products 100 is not lost.

Maintaining control over the individual products also involves re-ordering the products so as to form consecutive series of products, namely series of products where there are no gaps between one product and the following or preceding product.

In fact, the retaining device 7 causes the release of housing elements 5 to the positioning device 6 depending on the presence or absence of products 100 within the line which is transferred by the pick-up device 2.

The positioning device 6 therefore positions in the unloading zone a number of housing elements 5 corresponding to the products 100 which are to be unloaded, eliminating any empty positions originally present in the row of products 100.

Moreover, the apparatus for transferring products has small dimensions since it is not required to have any buffer zone for accumulating the products 100 and perform reorganization of the products 100 accumulated in the buffer zone.

1. An apparatus for transferring products, in particular products for ice-cream parlors, comprising:
a pick-up and release device (2) for at least one orderly row of products (100), comprising a plurality of grippers (3) each designed to grip a product (100), the pick-up and release device (2) being movable between a loading position in which the grippers (3) grip the orderly row of products (100) and an unloading position in which the grippers (3) release the products (100);
a sensor element (4) for generating a presence signal (PS) indicating the presence or absence of products in the orderly row of products (100);
a plurality of housing elements (5) each designed to house one of the products (100);
a positioning device (6) acting on the housing elements (5) for feeding forward in succession the housing elements (5) and positioning them in the unloading position of the pick-up device (2) so that the housing elements (5) receive the products (100) released by the grippers (3);
a retaining device (7) acting on the housing elements (5) and operatively associated with the sensor element (4) and with the positioning device (6) for transferring a housing element (5) to the positioning device (6) depending on the presence signal (PS) generated by the sensor element (4).

2. The apparatus according to claim 1, comprising a conveying device (13) acting on the housing elements (5), moving them between a zone (AZ) for accumulating empty housing elements, located upstream of the retaining device (7), a zone (LZ) for loading housing elements, in which the positioning device (6) operates, and an accumulation zone (FZ) for housing elements containing respective products (100), located downstream of the positioning device (6).

3. The apparatus according to claim 1, comprising a command and control device (31) operatively associated with the sensor element (4) and with the retaining device (7); the command and control device (31) receiving the presence signal (PS) sent by the sensor element (4) and generating and sending a retaining signal (RS) to the retaining device (7) for allowing or preventing the transfer of a housing element (5) to the positioning device (6).

4. The apparatus according to claim 1, wherein the retaining device (7) comprises at least one stop member (17) which can be switched between a stop position and a release position for a housing element (5).

5. The apparatus according to claim 4, wherein the retaining device (7) comprises a plurality of stop members (17); the stop members (17) being formed by a sprocket wheel (18) rotatable about an axis (Y) perpendicular to a direction of feeding (A) of the housing elements (5).

6. The apparatus according to claim 3, wherein the command and control device (31) is also operatively associated with the positioning device (6) and with a further sensor element (32); the further sensor element (32) generating and sending to the command and control device (31) an approach signal (AS) indicating that the pick-up and release device (2) has actually reached or almost reached the unloading position; the command and control device (31) receiving the approach signal (AS) sent by the further sensor element (32) and generating and sending an activation signal (ACTS) to the positioning device (6) for feeding forward in succession the housing elements (5).

7. The apparatus according to claim 1, wherein the positioning device (6) comprises a closed-loop conveyor (8) equipped with a plurality of retaining members (9) constrained to the conveyor (8) for engaging with and retaining the housing elements (5).

8. The apparatus according to claim 7, wherein the positioning device (6) comprises a stepper motor (11) for moving the closed-loop conveyor (8).

9. The apparatus according to claim 2, wherein the conveying device (13) comprises a closed-loop conveyor (14) on which the housing elements (5) are constrained in floating fashion, being held on the conveyor (14) by friction.

10. The apparatus according to claim 9, wherein the conveying device (13) comprises a motor (16) for moving the closed-loop conveyor (14) with continuous motion.

11. The apparatus according to claim 1, wherein the pick-up device (2) comprises at least two parallel rows of grippers (3) for simultaneously gripping two rows of products (100).

12. The apparatus according to claim 11, wherein the pick-up and release device (2) comprises actuator members (20) acting on the grippers (3) for moving the two rows of grippers (3) away from each other and simultaneously rotating the grippers (3), about two parallel axes of rotation (R), between two positions which are substantially perpendicular to each other.

13. The apparatus according to claim 12, wherein the actuator members (20) comprise two gear wheels (21) able to slide in a travel direction which is substantially perpendicular to the axes of rotation (R) of the grippers (3) and in opposite directions and a respective toothed circular sector (22) integral with each row of grippers (3); each toothed circular sector (22) being engaged by a respective gear wheel (21).

14. The apparatus according to claim 13, wherein each gear wheel (21) is rotatably constrained to a slide (23) which is able to slide in the travel direction; the gear wheel (23) engaging with a rack (25) during sliding of the slide (23) for rotating and causing rotation of the toothed circular sector (22).

15. The apparatus according to claim 14, wherein the actuator members (20) comprise a motor-driven shaft (26) rotatable about an axis parallel to the axes of rotation (R) of the grippers (3) and a respective mechanism (28) of the connecting rod—crank type acting between the motor-driven shaft (26) and each slide (23) for moving each slide (23).
